(19) United States
(12) Patent Application Publication
(10) Pub. No.: US 2023/0069551 A1
(43) Pub. Date: Mar. 2, 2023

(54) METHOD FOR PRODUCING LIQUID CRYSTALLINE POLYESTER AND LIQUID CRYSTALLINE POLYESTER

(71) Applicant: SUMITOMO CHEMICAL COMPANY, LIMITED, Tokyo (JP)

(72) Inventors: Shinji OHTOMO, Tsukuba-shi (JP); Hiromi YAMANISHI, Osaka-shi (JP)

(21) Appl. No.: 17/785,225

(22) PCT Filed: Dec. 8, 2020
(86) PCT No.: PCT/JP2020/045567

§ 371 Date: Jun. 14, 2022

(30) Foreign Application Priority Data
Dec. 19, 2019 (JP) 2019-229406

(51) Int. Cl. C08G 63/60

(52) U.S. Cl. CPC C08G 63/605

(57) ABSTRACT

What is provided is a method for producing a liquid crystalline polyester, the method including reacting an aromatic diol (A), an aromatic hydroxycarboxylic acid (B), and a naphthalenedicarboxylic acid (C) to obtain a liquid crystalline polyester, in which the naphthalenedicarboxylic acid (C) is a naphthalenedicarboxylic acid powder including 90% by mass or more of naphthalenedicarboxylic acid particles (C1) having a particle size of less than 150 μm as measured by the dry sieving test method of JIS K 0069 (1992).

### TECHNICAL FIELD

The present invention relates to a method for producing a liquid crystalline polyester and a liquid crystalline polyester.

Priority is claimed on Japanese Patent Application No. 2019-229406, filed Dec. 19, 2019, the content of which is incorporated herein by reference.

### BACKGROUND ART

Liquid crystalline polyesters having an aromatic ring skeleton have been used in the electric and electronic fields in recent years as materials having excellent heat resistance and tensile strength. A liquid crystalline polyester is produced by, for example, a method of adding acetic anhydride to an aromatic hydroxycarboxylic acid such as 4-hydroxybenzoic acid and/or an aromatic diol such as 4,4′-hydroxybiphenyl to acylate a phenolic hydroxyl group to obtain an acylation product, and transesterifying the obtained acylation product and an aromatic dicarboxylic acid such as naphthalenedicarboxylic acid or terephthalic acid, or the like.

For example, Patent Documents 1 to 3 disclose methods for producing a liquid crystalline polyester by performing transesterification in the presence of a naphthalenedicarboxylic acid. Since a liquid crystalline polyester obtained by the producing method has excellent heat resistance and mechanical strength and has little variation in quality, the liquid crystalline polyester is considered to be suitable as a material for electrical and electronic components.

### CITATION LIST

### Patent Documents

### [Patent Document 1]

Japanese Unexamined Patent Application, First Publication No. 2005-272810

### [Patent Document 2]

Japanese Unexamined Patent Application, First Publication No. 2005-272819

### [Patent Document 3]

Japanese Unexamined Patent Application, First Publication No. 2002-037869

### SUMMARY OF INVENTION

### Technical Problem

However, in recent years, along with the size reduction of electronic components, there is a demand for further improvement in the mechanical strength of thin-walled electronic components. Further improvement in mechanical strength is also required for thin-walled electronic components that use the liquid crystalline polyesters described in these related art documents as a material.

An object of the present invention is to provide a method for producing a liquid crystalline polyester that can have excellent mechanical strength, particularly excellent tensile properties, as compared with a liquid crystalline polyester having the same composition and manufactured by using a conventional naphthalenedicarboxylic acid.

### Solution to Problem

In order to solve the above-described problems, the present invention employs the following configurations.

[1] A method for producing a liquid crystalline polyester, the method including reacting an aromatic diol (A), an aromatic hydroxycarboxylic acid (B), and a naphthalenedicarboxylic acid (C) to obtain a liquid crystalline polyester,

wherein the naphthalenedicarboxylic acid (C) is a naphthalenedicarboxylic acid powder including 90% by mass or more of naphthalenedicarboxylic acid particles (C1) having a particle size of less than 150 μm as measured by a dry sieving test method of JIS K 0069 (1992).

[2] The method for producing a liquid crystalline polyester according to the above-described item [1], in which an amount of use of the naphthalenedicarboxylic acid (C) is 10 mol % or more with respect to a total amount of use (100 mol %) of the aromatic diol (A), the aromatic hydroxycarboxylic acid (B), and the naphthalenedicarboxylic acid (C).

[3] The method for producing a liquid crystalline polyester according to the above-described item [1] or [2], in which the naphthalenedicarboxylic acid (C) is at least one selected from the group consisting of 2,6-naphthalenedicarboxylic acid, 2,7-naphthalenedicarboxylic acid, and 1,4-naphthalenedicarboxylic acid.

[4] The method for producing a liquid crystalline polyester according to any one of the above-described items [1] to [3], in which a median particle size (D50) of the naphthalenedicarboxylic acid powder measured by a laser diffraction and scattering method is 5 to 30 μm.

[5] The method for producing a liquid crystalline polyester according to any one of the above-described items [1] to [4], in which the method has a step (i) of subjecting at least one of the aromatic diol (A) and the aromatic hydroxycarboxylic acid (B) to an acylation reaction with a fatty acid anhydride to obtain an acylation product, and

a step (ii) of subjecting the acylation product and the naphthalenedicarboxylic acid (C) to a transesterification reaction to obtain a liquid crystalline polyester.

[6] The method for producing a liquid crystalline polyester according to the above-described item [5], in which the transesterification reaction in the step (ii) is carried out from 250° C. to 350° C.

[7] The method for producing a liquid crystalline polyester according to any one of the above-described items [1] to [6], in which the method has a step (iii) of preparing a naphthalenedicarboxylic acid powder including 90% by mass or more of the naphthalenedicarboxylic acid particles (C1), and

the step (iii) includes

an operation (a) of classifying naphthalenedicarboxylic acid (C0) into the naphthalenedicarboxylic acid particles (C1) and naphthalenedicarboxylic acid particles (C2) having a particle size of 150 μm or more, by the dry sieving test method of JIS K 0069 (1992).

[8] The method for producing a liquid crystalline polyester according to any one of the above-described items [1] to [7], in which the method has a step (iii) of preparing a naphthalenedicarboxylic acid powder including 90% by mass or more of the naphthalenedicarboxylic acid particles (C1), and

the step (iii) includes

an operation (a) of classifying naphthalenedicarboxylic acid (C0) into the naphthalenedicarboxylic acid particles (C1) and naphthalenedicarboxylic acid particles (C2) having a particle size of 150 μm or more, by the dry sieving test method of JIS K 0069 (1992),

an operation (b) of processing the naphthalenedicarboxylic acid particles (C2) to produce naphthalenedicarboxylic acid particles (C2*) having a particle size adjusted to less than 150 μm, and

an operation (c) of mixing the naphthalenedicarboxylic acid particles (C1) obtained by the operation (a) with the naphthalenedicarboxylic acid particles (C2*) obtained by the operation (b).

[9] A liquid crystalline polyester obtainable by reacting an aromatic diol (A), an aromatic hydroxycarboxylic acid (B), and a naphthalenedicarboxylic acid (C),

wherein the naphthalenedicarboxylic acid (C) is a naphthalenedicarboxylic acid powder including 90% by mass or more of naphthalenedicarboxylic acid particles (C1) having a particle size of less than 150 μm as measured by a dry sieving test method of JIS K 0069 (1992).

### Advantageous Effects of Invention

The method for producing a liquid crystalline polyester of the present invention allows producing of a liquid crystalline polyester having excellent mechanical strength, particularly excellent tensile properties, as compared with a liquid crystalline polyester having the same composition and manufactured by using a conventional naphthalenedicarboxylic acid.

### DESCRIPTION OF EMBODIMENTS

<<Method for Producing Liquid Crystalline Polyester>>

### First Embodiment

The method for producing a liquid crystalline polyester of the present embodiment is a method for producing a liquid crystalline polyester, the method including reacting an aromatic diol (A), an aromatic hydroxycarboxylic acid (B), and a naphthalenedicarboxylic acid (C) to obtain a liquid crystalline polyester, in which the naphthalenedicarboxylic acid (C) is a naphthalenedicarboxylic acid powder including 90% by mass or more of naphthalenedicarboxylic acid particles (C1) having a particle size of less than 150 μm as measured by a dry sieving test method of JIS K 0069 (1992).

Naphthalenedicarboxylic Acid (C)

As 90% by mass or more of the naphthalenedicarboxylic acid particles (C1) having a particle size of less than 150 μm are included with respect to 100% by mass of the total mass of the naphthalenedicarboxylic acid (C), the method for producing a liquid crystalline polyester of the present embodiment allows producing of a liquid crystalline polyester having excellent mechanical strength, particularly excellent tensile properties, as compared with a liquid crystalline polyester having the same composition and manufactured by using a conventional naphthalenedicarboxylic acid.

The naphthalenedicarboxylic acid (C) includes preferably 95% by mass or more, more preferably 98% by mass or more, and even more preferably 99% by mass or more, of the naphthalenedicarboxylic acid particles (C1) having a particle size of less than 150 μm with respect to 100% by mass of the total mass of the naphthalenedicarboxylic acid (C), and the naphthalenedicarboxylic acid (C) may be one that include 100% by mass of the naphthalenedicarboxylic acid particles (C1).

It is preferable that the median particle size (D50) of the naphthalenedicarboxylic acid powder measured by a laser diffraction and scattering method is 5 to 30 μm.

According to the present specification, the median particle size (D50) of the naphthalenedicarboxylic acid powder mean the particle size of particles obtained by measuring the particle size and the volume fractions of the naphthalenedicarboxylic acid powder by a laser diffraction and scattering method, and sequentially integrating the volume fractions from the smallest particle size, and determining the particle size at which the integrated volume is 50% of the total volume of all particles.

The median particle size (D50) of the naphthalenedicarboxylic acid powder is preferably 30 μm or less, more preferably 24 μm or less, and even more preferably 14.5 μm or less. The smaller median particle size (D50) of the naphthalenedicarboxylic acid powder is, the larger specific surface area of the naphthalenedicarboxylic acid is, and the more number of contact points of the aromatic diol (A), the aromatic hydroxycarboxylic acid (B), and the reaction solvent with the naphthalenedicarboxylic acid powder, so that a polycondensation reaction can be caused to proceed more rapidly. The lower limit of the median particle size (D50) of the naphthalenedicarboxylic acid powder is not limited; however, from the viewpoint of being easily pulverizable by a pulverizer, the lower limit may be 5 μm or more, 8 μm or more, 10 μm or more, or 12 μm or more.

The amount of use of the naphthalenedicarboxylic acid (C) according to the present embodiment is preferably 10 mol % or more, more preferably 10 to 35 mol %, even more preferably 15 to 30 mol %, and particularly preferably 17.5 to 25 mol %, with respect to the total amount of use (100 mol %) of the aromatic diol (A), the aromatic hydroxycarboxylic acid (B), and the naphthalenedicarboxylic acid (C).

The naphthalenedicarboxylic acid (C) is represented by the following Formula (C):

HOOC—Ar³—COOH (C)

in the formula, Ar³ represents a naphthylene group.

Examples of the naphthylene group include a 2,6-naphthylene group, a 1,5-naphthylene group, a 2,7-naphthylene group, a 1,4-naphthylene group, and a 1,6-naphthylene group.

Specific examples of the naphthalenedicarboxylic acid (C) according to the present embodiment include 2,6-naphthalenedicarboxylic acid, 1,5-naphthalenedicarboxylic acid, 2,7-naphthalenedicarboxylic acid, and 1,4-naphthalenedicarboxylic acid, as well as a 1,6-naphthalenedicarboxylic acid. Above all, 2,6-naphthalenedicarboxylic acid, 2,7-naphthalenedicarboxylic acid, and 1,4-naphthalenedicarboxylic acid are preferred, and 2,6-naphthalenedicarboxylic acid is most preferred.

Aromatic Hydroxycarboxylic Acid (B)

According to the present specification, the aromatic hydroxycarboxylic acid (B) refers to a compound having at least one or more aromatic rings, in which a hydroxy group (that is, a phenolic hydroxyl group) is directly bonded to the aromatic ring, and a carboxy group is directly bonded to the aromatic ring. The aromatic ring to which a hydroxy group is bonded and the aromatic ring to which a carboxy group is bonded may be the same aromatic ring in a molecule or may be different aromatic rings in a molecule. That is, the aromatic hydroxycarboxylic acid (B) may be an aromatic hydroxycarboxylic acid in which a hydroxy group and a carboxy group are bonded to the same aromatic ring in a molecule, such as, for example, 4-hydroxybenzoic acid, or may be an aromatic hydroxycarboxylic acid in which a hydroxy group is bonded to one aromatic ring in a molecule and a carboxy group is bonded to another aromatic ring in a molecule, such as, for example, 4-hydroxy-4′-biphenylcarboxylic acid.

Regarding the aromatic hydroxycarboxylic acid (B), an aromatic hydroxycarboxylic acid represented by the following Formula (B) (hereinafter, also referred to as aromatic hydroxycarboxylic acid (B)) may be included:

HO—Ar¹—COOH (B)

in the formula, Ar¹ represents an arylene group which may be substituted.

Examples of the arylene group include a phenylene group, a naphthylene group, and a biphenylylene group.

The arylene group may be substituted with a halogen atom, an alkyl group having 1 to 6 carbon atoms, or the like. Examples of the halogen atom include a fluorine atom, a chlorine atom, a bromine atom, and an iodine atom.

Examples of the alkyl group having 1 to 6 carbon atoms include a methyl group, an ethyl group, a propyl group, an isopropyl group, a butyl group, and a t-butyl group.

Specific examples of the aromatic hydroxycarboxylic acid (B) according to the present embodiment include 4-hydroxybenzoic acid, 3-hydroxybenzoic acid, 2-hydroxy-6-naphthoic acid, 2-hydroxy-3-naphthoic acid, 1-hydroxy-4-naphthoic acid, 2,6-dichloro-4-hydroxybenzoic acid, 2-chloro-4-hydroxybenzoic acid, 2,6-difluoro-4-hydroxybenzoic acid, 4-hydroxy-4′-biphenylcarboxylic acid.

Among the above-described ones, from the viewpoint of being considered to be easily available, 4-hydroxybenzoic acid and 2-hydroxy-6-naphthoic acid are preferred, and 2-hydroxy-6-naphthoic acid is more preferred.

Regarding the aromatic hydroxycarboxylic acid (B) according to the present embodiment, the above-described compounds may be used singly, or two or more kinds thereof may be used in combination.

Aromatic Diol (A)

According to the present specification, the aromatic diol (A) refers to a compound having at least one or more aromatic rings, in which two hydroxy groups (that is, phenolic hydroxyl groups) are directly bonded to the aromatic ring. The aromatic ring to which the hydroxy groups are bonded may be the same aromatic ring in a molecule or may be different aromatic rings in a molecule. That is, the aromatic diol (A) may be an aromatic diol in which two hydroxy groups are bonded to the same aromatic ring in a molecule, such as, for example, hydroquinone, or may be an aromatic diol in which a hydroxy group is bonded to one aromatic ring in a molecule and another hydroxy group is bonded to another aromatic ring in a molecule, such as, for example, 4,4′-dihydroxybiphenyl.

Regarding the aromatic diol (A), an aromatic diol represented by the following Formula (A) (hereinafter, also referred to as aromatic diol (A)) may be included:

HO—Ar²—OH (A)

in the formula, Ar² represents an arylene group which may be substituted, or a divalent linking group represented by the following Formula (IV):

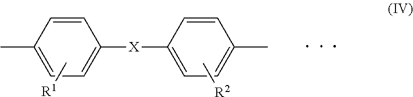

in the formula, R¹ and R² each independently represent a hydrogen atom, a halogen atom, an acyloxy group having 1 to 6 carbon atoms, or an alkyl group having 1 to 6 carbon atoms; and X represents —O—, —S—, —SO₂—, —CO—, —C₆H₁₀—, or an alkylene group.

In the above-described Formula (A), Ar² represents an arylene group which may be substituted, or a divalent linking group represented by the above-described Formula (IV).

Examples of the arylene group include a phenylene group, a naphthylene group, and a biphenylylene group.

The arylene group may be substituted with a halogen atom, an alkyl group having 1 to 6 carbon atoms, an acyloxy group having 1 to 6 carbon atoms, a phenyl group, a nitro group, or the like.

Examples of the halogen atom include a fluorine atom, a chlorine atom, a bromine atom, and an iodine atom, and examples of the alkyl group having 1 to 6 carbon atoms include a methyl group, an ethyl group, a propyl group, an isopropyl group, a butyl group, and a t-butyl group.

Examples of the acyloxy group having 1 to 6 carbon atoms include a formyloxy group, an acetyloxy group, and a propyloxy group.

In the above-described Formula (IV), R¹ and R² each independently represent a hydrogen atom, a halogen atom, an acyloxy group having 1 to 6 carbon atoms, or an alkyl group having 1 to 6 carbon atoms.

Examples of the halogen atom include a fluorine atom, a chlorine atom, a bromine atom, and an iodine atom, and examples of the alkyl group having 1 to 6 carbon atoms include a methyl group, an ethyl group, a propyl group, an isopropyl group, a butyl group, and a t-butyl group.

Examples of the acyloxy group having 1 to 6 carbon atoms include a formyloxy group, an acetyloxy group, and a propionyloxy group.

In the above-described Formula (IV), X represents —O—, —S—, —SO₂—, —CO—, —C₆H₁₀—, or an alkylene group. Regarding the alkylene group, a branched or linear alkylene group may be included. Examples of the linear alkylene group include a methylene group [—CH₂—], an ethylene group [—(CH₂)₂—], a trimethylene group [—(CH₂)₃—], and a tetramethylene group [—(CH₂)₄—], and a pentamethylene group [—(CH₂)₅—]. Examples of the branched alkylene group include alkylalkylene groups, such as an alkylmethylene group such as —CH(CH₃)—, —CH(CH₂CH₃)—, or —C(CH₃)₂—; an alkylethylene group such as —CH(CH₃)CH₂— or —C(CH₂CH₃)₂—CH₂—; an alkyltrimethylene group such as —CH(CH₃)CH₂CH₂— or —CH₂CH(CH₃)CH₂—; and an alkyltetramethylene group such as —CH(CH₃)CH₂CH₂CH₂— or —CH₂CH(CH₃)CH₂CH₂—.

In the above-described Formula (A), examples of Ar² include the following groups:

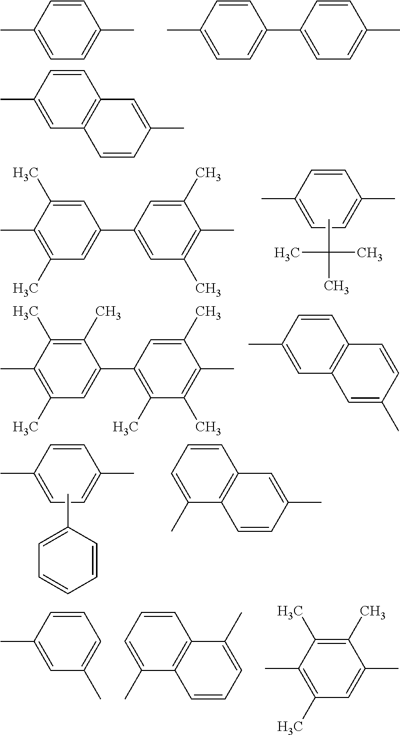

Specific examples of the aromatic diol (A) according to the present embodiment include 4,4′-dihydroxybiphenyl, hydroquinone, resorcin, methylhydroquinone, 2,3,5-trimethylhydroquinone, chlorohydroquinone, acetoxyhydroquinone, nitrohydroquinone, 2,2′,3,3′,5,5′-hexamethyl-4,4′-biphenol, 1,4-dihydroxynaphthalene, 1,5-dihydroxynaphthalene, 1,6-dihydroxynaphthalene, 2,6-dihydroxynaphthalene, 2,7-dihydroxynaphthalene, 2,2-bis(4-hydroxyphenyl)propane, 2,2-bis(4-hydroxy-3,5-dimethylphenyl)propane, 2,2-bis(4-hydroxy)-3,5-dichlorophenyl)propane, 2,2-bis(4-hydroxy-3-methylphenyl)propane, 2,2-bis(4-hydroxy-3-chlorophenyl)propane, bis-(4-hydroxyphenyl)methane, bis-(4-hydroxy-3,5-dimethylphenyl)methane, bis-(4-hydroxy-3,5-dichlorophenyl)methane, bis-(4-hydroxy-3,5-dibromophenyl)methane, bis-(4-hydroxy-3-methylphenyl)methane, bis-(4-hydroxy-3-chlorophenyl)methane, 1,1-bis(4-hydroxyphenyl)cyclohexane, bis-(4-hydroxyphenyl) ketone, bis-(4-hydroxy-3,5-dimethylphenyl) ketone, bis-(4-hydroxy-3,5-dichlorophenyl) ketone, bis-(4-hydroxyphenyl) sulfide, bis-(4-hydroxyphenyl)sulfone, and bis-(4-hydroxyphenyl) ether.

Among the above-described ones, from the viewpoint of being considered to be easily available, 4,4′-dihydroxybiphenyl, hydroquinone, resorcin, 2,6-dihydroxynaphthalene, 2,7-dihydroxynaphthalene, 2,2-bis(4-hydroxyphenyl)propane, and bis-(4-hydroxyphenyl)sulfone are preferred, and 4,4′-dihydroxybiphenyl and hydroquinone are more preferred.

Regarding the aromatic diol (A) in the present embodiment, the above-described compounds may be used singly, or two or more kinds thereof may be used in combination.

Aromatic Dicarboxylic Acid (D)

In the method for producing a liquid crystalline polyester of the present embodiment, an aromatic dicarboxylic acid (D) other than the naphthalenedicarboxylic acid (C) may be reacted together with the naphthalenedicarboxylic acid (C).

Regarding the aromatic dicarboxylic acid (D), an aromatic dicarboxylic acid represented by the following Formula (D) (hereinafter, also referred to as aromatic dicarboxylic acid (D)) may be included:

HOOC—Ar⁴—COOH (D)

in the formula, Ar⁴ represents an arylene group which may be substituted, or a divalent linking group represented by the following Formula (IV); provided that an unsubstituted naphthylene group is excluded.

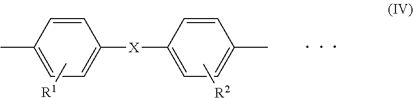

in the formula, R¹ and R² each independently represent a hydrogen atom, a halogen atom, an acyloxy group having 1 to 6 carbon atoms, or an alkyl group having 1 to 6 carbon atoms; and X represents —O—, —S—, —SO₂—, —CO—, —C₆H₁₀—, or an alkylene group.

Ar⁴ in the above-described Formula (D) represents an arylene group which may be substituted, or a divalent linking group represented by the above-described Formula (IV). However, an unsubstituted naphthylene group is excluded.

Examples of the arylene group include a phenylene group and a biphenylylene group.

The arylene group may be substituted with a halogen atom, an alkyl group having 1 to 6 carbon atoms, or the like. Examples of the halogen atom include a fluorine atom, a chlorine atom, a bromine atom, and an iodine atom. Examples of the alkyl group having 1 to 6 carbon atoms include a methyl group, an ethyl group, a propyl group, an isopropyl group, a butyl group, and a t-butyl group.

Regarding the halogen atom, the acyloxy group having 1 to 6 carbon atoms, and the alkyl group having 1 to 6 carbon atoms, the same ones as described above may be included.

The divalent linking group represented by the above-described Formula (IV) is similar to the content described in the above-described Formula (A).

Specific examples of the aromatic dicarboxylic acid (D) include terephthalic acid, isophthalic acid, 4,4′-biphenyldicarboxylic acid, methylterephthalic acid, methylisophthalic acid, and 4,4′-dicarboxydiphenyl ether. Above all, terephthalic acid and isophthalic acid are preferred.

The method for producing a liquid crystalline polyester according to the present embodiment preferably has a step (i) of subjecting at least one of the aromatic diol (A) and the aromatic hydroxycarboxylic acid (B) to an acylation reaction with a fatty acid anhydride to obtain an acylation product; and

a step (ii) of subjecting the acylation product and the naphthalenedicarboxylic acid (C) to a transesterification reaction to obtain a liquid crystalline polyester.

### Second Embodiment

The method for producing a liquid crystalline polyester according to the present embodiment preferably has a step (i) of subjecting at least one of the aromatic diol (A) and the aromatic hydroxycarboxylic acid (B) to an acylation reaction with a fatty acid anhydride to obtain an acylation product; and

a step (ii) of subjecting the acylation product and the naphthalenedicarboxylic acid (C) to a transesterification reaction to obtain a liquid crystalline polyester,

in which the transesterification reaction in the step (ii) is carried out from 250° C. to 350° C.

In the method for producing a liquid crystalline polyester of the present embodiment, an aromatic diol (A), an aromatic hydroxycarboxylic acid (B), and a naphthalenedicarboxylic acid (C) may be added together to a reaction system, and after going through the step (i) of obtaining an acylation product, the process may be moved to the step (ii) of obtaining the liquid crystalline polyester, or alternatively, after going through the step (i) of obtaining the acylation product in the presence of the aromatic diol (A) and the aromatic hydroxycarboxylic acid (B), the naphthalenedicarboxylic acid (C) may be added to the reaction system, and then the process may be moved to the step (ii) of obtaining the liquid crystalline polyester.

[Step (i)]

Step (i) is a step of subjecting at least one of the aromatic diol (A) and the aromatic hydroxycarboxylic acid (B) to an acylation reaction with a fatty acid anhydride to obtain an acylation product.

Step (i) may also be a step of subjecting both the aromatic diol (A) and the aromatic hydroxycarboxylic acid (B) together with a fatty acid anhydride to an acylation reaction to obtain an acylation product.

Furthermore, the step (i) may also be a step of subjecting any one of the aromatic diol (A) or the aromatic hydroxycarboxylic acid (B) and a fatty acid anhydride to an acylation reaction to obtain an acylation product. In this case, a step of subjecting the other one of the aromatic diol (A) or the aromatic hydroxycarboxylic acid (B) and a fatty acid anhydride to an acylation reaction to obtain an acylation product may be separately provided, or a step of directly polymerizing the other one of the aromatic diol (A) or the aromatic hydroxycarboxylic acid (B) and the naphthalenedicarboxylic acid (C) may be separately provided.

Fatty Acid Anhydride

Regarding the fatty acid anhydride, a fatty acid anhydride having 9 or fewer carbon atoms may be included.

Examples of the fatty acid anhydride having 9 or fewer carbon atoms according to the present embodiment include acetic anhydride, propionic anhydride, butanoic anhydride, 2-methylpropionic anhydride, pentanoic anhydride, 2,2-dimethylpropionic anhydride, 2-ethylhexanoic anhydride, monochloroacetic anhydride, dichloroacetic anhydride, trichloracetic anhydride, monobromoacetic anhydride, dibromoacetic anhydride, tribromoacetic anhydride, monofluoroacetic anhydride, difluoroacetic anhydride, trifluoroacetic anhydride, pentane-1,5-dicarboxylic acid anhydride, maleic anhydride, succinic anhydride, and β-bromopropionic anhydride.

In the step (i) according to the present embodiment, the amount of use of the aromatic diol (A) is preferably 10 to 50 mol %, more preferably 20 to 40 mol %, and even more preferably 20 to 30 mol %, with respect to the sum (100 mol %) of the aromatic diol (A) and the aromatic hydroxycarboxylic acid (B) used in the step (i).

In the step (i) according to the present embodiment, the amount of use of the aromatic hydroxycarboxylic acid (B) is preferably 50 to 90 mol %, more preferably 60 to 80 mol %, and even more preferably 70 to 80 mol %, with respect to the sum (100 mol %) of the aromatic diol (A) and the aromatic hydroxycarboxylic acid (B) used in the step (i).

In the step (i) according to the present embodiment, the amount of use of the fatty acid anhydride having 9 or fewer carbon atoms is preferably 1.01 to 1.55 times equivalent, and more preferably 1.05 to 1.42 times equivalent, to the phenolic hydroxyl groups.

When the amount of use of the fatty acid anhydride is equal to or more than the above-described preferred lower limit value, the equilibrium in acylation shifts to the fatty acid anhydride side, and the progress of polymerization into a polyester becomes faster.

Furthermore, when the amount of use of the fatty acid anhydride is equal to or less than the above-mentioned preferred upper limit value, deterioration such as coloring of the obtainable liquid crystalline polyester can be further suppressed.

The step (i) according to the present embodiment is preferably carried out from 120° C. to 150° C. for 10 minutes to 5 hours, more preferably from 130° C. to 150° C. for 20 minutes to 3 hours, and particularly preferably from 135° C. to 150° C. for 20 minutes to 1 hour.

[Step (ii)]

Step (ii) is a step of subjecting the acylation product obtainable by the above-mentioned step (i) and the naphthalenedicarboxylic acid (C) to a transesterification reaction to obtain a liquid crystalline polyester.

Together with the naphthalenedicarboxylic acid (C), an aromatic dicarboxylic acid (D) other than the naphthalenedicarboxylic acid (C) may be subjected to a transesterification reaction, or together with the naphthalenedicarboxylic acid (C), an aromatic hydroxycarboxylic acid and an aromatic diol may be subjected to transesterification reaction.

Examples of the aromatic hydroxycarboxylic acid include compounds similar to the aromatic hydroxycarboxylic acid (B) used in the above-mentioned step (i).

In the step (ii) according to the present embodiment, the amount of use of the naphthalenedicarboxylic acid (C) is preferably 10 mol % or more, more preferably 10 to 35 mol %, even more preferably 15 to 30 mol %, and particularly preferably 17.5 to 25 mol %, with respect to the total amount of use (100 mol %) of the aromatic diol (A), the aromatic hydroxycarboxylic acid (B), and the naphthalenedicarboxylic acid (C).

In the step (ii) according to the present embodiment, the amount of use of the aromatic dicarboxylic acid (D) may be 0 mol %, preferably 0 to 15 mol %, more preferably 0 to 10 mol %, even more preferably 0 to 5 mol %, and particularly preferably 0 to 3 mol %, with respect to the total amount of use (100 mol %) of the aromatic diol (A), the aromatic hydroxycarboxylic acid (B), and the naphthalenedicarboxylic acid (C).

In the step (ii) according to the present embodiment, the transesterification reaction in the step (ii) is carried out from 250° C. to 350° C. In the step (ii) in the present embodiment, it is preferable that the temperature is raised from 120° C.-150° C. to 300° C.-350° C. over 0.1 to 10° C./min and then reaction is performed from 250° C. to 350° C., and it is more preferable that the temperature is raised from 130° C.-135° C. to 280° C.-330° C. at a proportion of 0.3 to 5° C./min and then reaction is performed from 250° C. to 350° C.

When an acylated fatty acid ester and an aromatic dicarboxylic acid are subjected to a transesterification reaction, it is preferable to evaporate and remove any by-produced fatty acids and unreacted fatty acid anhydride out of the system in order to shift the equilibrium.

As 90% by mass or more of the naphthalenedicarboxylic acid particles (C1) having a particle size of less than 150 μm are included with respect to 100% by mass of the total mass of the naphthalenedicarboxylic acid (C), the method for producing a liquid crystalline polyester of the present embodiment allows producing of a liquid crystalline polyester having excellent mechanical strength, particularly excellent tensile properties, as compared with a liquid crystalline polyester having the same composition and manufactured by using a conventional naphthalenedicarboxylic acid.

### Other Embodiments

It is preferable that the method for producing a liquid crystalline polyester of the present embodiment has a step (iii) of preparing a naphthalenedicarboxylic acid powder including 90% by mass or more of the naphthalenedicarboxylic acid particles (C1),

the step (iii) includes

an operation (a) of classifying naphthalenedicarboxylic acid (C0) into the naphthalenedicarboxylic acid particles (C1) and the naphthalenedicarboxylic acid particles (C2) having a particle size of 150 μm or more by a dry sieving test method of JIS K 0069 (1992).

According to the method for producing a liquid crystalline polyester of the present embodiment, as the naphthalenedicarboxylic acid (C0), a commercially available 2,6-naphthalenedicarboxylic acid powder of which particle size has not been adjusted can be used.

It is preferable that the method for producing a liquid crystalline polyester of the present embodiment has a step (iii) of preparing a naphthalenedicarboxylic acid powder including 90% by mass or more of the naphthalenedicarboxylic acid particles (C1),

the step (iii) includes

an operation (a) of classifying naphthalenedicarboxylic acid (C0) into the naphthalenedicarboxylic acid particles (C1) and naphthalenedicarboxylic acid particles (C2) having a particle size of 150 μm or more, by the dry sieving test method of JIS K 0069 (1992),

an operation (b) of processing the naphthalenedicarboxylic acid particles (C2) to produce naphthalenedicarboxylic acid particles (C2*) having a particle size adjusted to less than 150 μm, and

an operation (c) of mixing the naphthalenedicarboxylic acid particles (C1) obtained by the operation (a) with the naphthalenedicarboxylic acid particles (C2*) obtained by the operation (b).

By processing the naphthalenedicarboxylic acid particles (C2) having a particle size of 150 μm or more to adjust the particle size to less than 150 μm, regardless of the particle size distribution of commercially available naphthalenedicarboxylic acid particles, the naphthalenedicarboxylic acid particles (C2) can be utilized as the naphthalenedicarboxylic acid particles (C2*) without wasting.

Regarding a method for processing the naphthalenedicarboxylic acid particles (C2) having a particle size of 150 μm or more, a known pulverization method can be used.

The method for producing a liquid crystalline polyester of the present invention has the following aspects.

“1” A method for producing a liquid crystalline polyester, the method including reacting an aromatic diol (A), an aromatic hydroxycarboxylic acid (B), and a naphthalenedicarboxylic acid (C) to obtain a liquid crystalline polyester,

in which the naphthalenedicarboxylic acid (C) is a naphthalenedicarboxylic acid powder including 90% by mass or more of naphthalenedicarboxylic acid particles (C1) having a particle size of less than 150 μm as measured by a dry sieving test method of JIS K 0069 (1992).

“2” The method for producing a liquid crystalline polyester according to the above-described item “1”, in which the naphthalenedicarboxylic acid (C) includes 95% by mass or more, preferably 98% by mass or more, more preferably 99% by mass or more, and even more preferably 100% by mass, of the naphthalenedicarboxylic acid particles (C1) having a particle size of less than 150 μm with respect to 100% by mass of the total mass of the naphthalenedicarboxylic acid (C).

“3” The method for producing a liquid crystalline polyester according to the above-described item “1” or “2”, in which the amount of use of the naphthalenedicarboxylic acid (C) is 10 mol % or more, preferably 10 to 35 mol %, more preferably 15 to 30 mol %, and even more preferably 17.5 to 25 mol %, with respect to the total amount of use (100 mol %) of the aromatic diol (A), the aromatic hydroxycarboxylic acid (B), and the naphthalenedicarboxylic acid (C).

“4” The method for producing a liquid crystalline polyester according to any one of the above-described items “1” to “3”, in which the naphthalenedicarboxylic acid (C) is at least one selected from the group consisting of 2,6-naphthalenedicarboxylic acid, 2.7-naphthalenedicarboxylic acid, and 1,4-naphthalenedicarboxylic acid.

“5” The method for producing a liquid crystalline polyester according to any one of the above-described items “1” to “4”, in which the median particle size (D50) of the naphthalenedicarboxylic acid powder measured by a laser diffraction and scattering method is 5 to 30 μm, preferably 24 μm or less, and more preferably 14.5 μm or less.

“6” The method for producing a liquid crystalline polyester according to the above-described item “5”, in which the median particle size (D50) of the naphthalenedicarboxylic acid powder is 5 μm or more, preferably 8 μm or more, more preferably 10 μm or more, and even more preferably 12 μm or more.

“7” The method for producing a liquid crystalline polyester according to any one of the above-described items “1” to “6”, in which the method includes: a step (i) of subjecting at least one of the aromatic diol (A) and the aromatic hydroxycarboxylic acid (B) to an acylation reaction with a fatty acid anhydride to obtain an acylation product; and

a step (ii) of subjecting the acylation product and the naphthalenedicarboxylic acid (C) to a transesterification reaction to obtain a liquid crystalline polyester.

“8” The method for producing a liquid crystalline polyester according to the above-described item “7”, in which the transesterification reaction in the step (ii) is carried out from 250° C. to 350° C.

“9” The method for producing a liquid crystalline polyester according to any one of the above-described items “1” to “8”, in which the method has a step (iii) of preparing a naphthalenedicarboxylic acid powder including 90% by mass or more of the naphthalenedicarboxylic acid particles (C1),

the step (iii) includes

an operation (a) of classifying naphthalenedicarboxylic acid (C0) into the naphthalenedicarboxylic acid particles (C1) and naphthalenedicarboxylic acid particles (C2) having a particle size of 150 μm or more, by the dry sieving test method of JIS K 0069 (1992).

“10” The method for producing a liquid crystalline polyester according to any one of the above-described items “1” to “9”, in which the method has a step (iii) of preparing a naphthalenedicarboxylic acid powder including 90% by mass or more of the naphthalenedicarboxylic acid particles (C1),

the step (iii) includes

an operation (a) of classifying naphthalenedicarboxylic acid (C0) into the naphthalenedicarboxylic acid particles (C1) and naphthalenedicarboxylic acid particles (C2) having a particle size of 150 μm or more, by the dry sieving test method of JIS K 0069 (1992),

an operation (b) of processing the naphthalenedicarboxylic acid particles (C2) to produce naphthalenedicarboxylic acid particles (C2*) having a particle size adjusted to less than 150 μm, and

an operation (c) of mixing the naphthalenedicarboxylic acid particles (C1) obtained by the operation (a) with the naphthalenedicarboxylic acid particles (C2*) obtained by the operation (b).

<<Liquid Crystalline Polyester>>

The liquid crystalline polyester according to the present embodiment is a liquid crystalline polyester obtainable by reacting an aromatic diol (A), an aromatic hydroxycarboxylic acid (B), and a naphthalenedicarboxylic acid (C), and

the naphthalenedicarboxylic acid (C) is a naphthalenedicarboxylic acid powder including 90% by mass or more of naphthalenedicarboxylic acid particles (C1) having a particle size of less than 150 μm as measured by the dry sieving test method of JIS K 0069 (1992).

As described above, the liquid crystalline polyester obtainable by reacting an aromatic diol (A), an aromatic hydroxycarboxylic acid (B), and a naphthalenedicarboxylic acid (C) can have excellent mechanical strength, particularly excellent tensile properties, as compared with a liquid crystalline polyester having the same composition and manufactured by using a conventional naphthalenedicarboxylic acid, by using a naphthalenedicarboxylic acid powder including 90% by mass or more of the naphthalenedicarboxylic acid particles (C1) having a particle size of less than 150 Elm, as the naphthalenedicarboxylic acid (C).

More specifically, regarding the liquid crystalline polyester according to the present embodiment, a liquid crystalline polyester including a constitutional unit represented by the following Formula (1) (hereinafter, also referred to as constitutional unit (1)), a constitutional unit represented by the following Formula (2) (hereinafter, also referred to as constitutional unit (2)), and a constitutional unit represented by the following Formula (3) (hereinafter, also referred to as constitutional unit (3)) may be included. The liquid crystalline polyester according to the present embodiment may further include a constitutional unit represented by the following Formula (4) (hereinafter, also referred to as constitutional unit (4)).

—O—Ar¹—CO— (1)

—O—Ar²—O— (2)

—CO—Ar³—CO— (3)

in which in Formula (1), Ar¹ represents an arylene group which may be substituted;

in Formula (2), Ar² represents an arylene group which may be substituted, or a divalent linking group represented by the following Formula (IV); and

in Formula (3), Ar³ represents a naphthylene group.

—CO—Ar⁴—CO— (4)

in the formula, Ar⁴ represents an arylene group which may be substituted, or a divalent linking group represented by the following Formula (IV); provided that an unsubstituted naphthylene group is excluded.

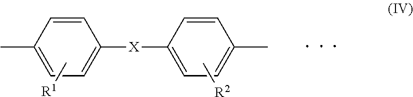

in the formula, R¹ and R² each independently represent a hydrogen atom, a halogen atom, an acyloxy group having 1 to 6 carbon atoms, or an alkyl group having 1 to 6 carbon atoms; and X represents —O—, —S—, —SO₂—, —CO—, —C₆H₁₀—, or an alkylene group.

<Constitutional Unit (1)>

Constitutional unit (1) is a constitutional unit represented by the above-described Formula (1).

In the Formula (1), Ar¹ represents an arylene group which may be substituted. Ar¹ may be a phenylene group, a naphthylene group, or a biphenylylene group. One or more hydrogen atoms in the group represented by Ar¹ may be substituted with a halogen atom, an alkyl group having 1 to 10 carbon atoms, or an aryl group having 6 to 20 carbon atoms.

Examples of the halogen atom that can substitute for one or more hydrogen atoms in the group represented by Ar¹ include a fluorine atom, a chlorine atom, a bromine atom, and an iodine atom.

Examples of the alkyl group having 1 to 10 carbon atoms that can substitute for one or more hydrogen atoms in the group represented by Ar¹ include a methyl group, an ethyl group, an n-propyl group, an isopropyl group, an n-butyl group, an isobutyl group, a sec-butyl group, a tert-butyl group, an n-hexyl group, an n-heptyl group, a 2-ethylhexyl group, an n-octyl group, an n-nonyl group, and an n-decyl group.

Examples of the aryl group having 6 to 20 carbon atoms that can substitute for one or more hydrogen atoms in the group represented by Ar¹ include monocyclic aromatic groups such as a phenyl group, an o-tolyl group, an m-tolyl group, and a p-tolyl group; and fused aromatic groups such as a 1-naphthyl group and a 2-naphthyl group.

When one or more hydrogen atoms in the group represented by Ar¹ are substituted with these groups, the number of substitutions is preferably 1 or 2, and more preferably 1.

The constitutional unit (1) is a constitutional unit derived from a predetermined aromatic hydroxycarboxylic acid (B).

Regarding the constitutional unit (1), it is preferable that Ar¹ is a 1,4-phenylene group (a constitutional unit derived from 4-hydroxybenzoic acid), and that Ar¹ is a 2,6-naphthylene group (a constitutional unit derived from 6-hydroxy-2-naphthoic acid).

<Constitutional Unit (2)>

Constitutional unit (2) is a constitutional unit represented by the above-described Formula (2).

In the Formula (2), Ar² represents an arylene group which may be substituted, or a group represented by the above-described Formula (4). Ar² may be a phenylene group, a naphthylene group, or a biphenylylene group. One or more hydrogen atoms included in Ar² may be substituted with a halogen atom, an alkyl group having 1 to 10 carbon atoms, or an aryl group having 6 to 20 carbon atoms.

The halogen atom, alkyl group, and aryl group, which can substitute for one or more hydrogen atoms in the group represented by Ar², are the same ones as the halogen atom, the alkyl group having 1 to 10 carbon atoms, and the aryl group having 6 to 20 carbon atoms, which can substitute for one or more hydrogen atoms in the above-described group represented by Ar¹.

When one or more hydrogen atoms in the group represented by Ar² are substituted with these groups, the number of substitutions is preferably one or two, and more preferably one, each independently for the group represented by Ar². It is more preferable that Ar² is unsubstituted.

The constitutional unit (2) is a constitutional unit derived from a predetermined aromatic diol (A).

Regarding the constitutional unit (2), it is preferable that Ar² is a 1,4-phenylene group (a constitutional unit derived from hydroquinone), that Ar² is a 1,3-phenylene group (a constitutional unit derived from 1,3-benzenediol), that Ar² is a 2,6-naphthylene group (a constitutional unit derived from 2,6-dihydroxynaphthalene), that Ar² is a 4,4′-biphenylylene group (a constitutional unit derived from 4,4′-dihydroxybiphenyl), or that Ar² is a diphenyl ether-4,4′-diyl group (a constitutional unit derived from 4,4′-dihydroxydiphenyl ether), and it is more preferable that Ar² is a 1,4-phenylene group, a 1,3-phenylene group, a 2,6-naphthylene group, or a 4,4′-biphenylylene group.

<Constitutional Unit (3)>

Constitutional unit (3) is a constitutional unit represented by the above-described Formula (3).

In the Formula (3), Ar³ represents a naphthylene group. Examples of the naphthylene group include a 2,6-naphthylene group, a 1,5-naphthylene group, a 2,7-naphthylene group, and a 1,4-naphthylene group.

The constitutional unit (3) is a constitutional unit derived from a predetermined naphthalenedicarboxylic acid (C).

Regarding the constitutional unit (3), it is more preferable that Ar³ is a 2,6-naphthylene group (a constitutional unit derived from 2,6-naphthalenedicarboxylic acid), that Ar³ is a 2,7-naphthylene group (a constitutional unit derived from 2,7-naphthalenedicarboxylic acid), and that Ar³ is a 1,4-naphthylene group (a constitutional unit derived from 1,4-naphthalenedicarboxylic acid).

The divalent linking group represented by the above-described Formula (IV) is similar to the content described in the above-described Formula (A).

<Constitutional Unit (4)>

Constitutional unit (4) is a constitutional unit represented by the above-described Formula (4).

In the Formula (4), Ar⁴ represents an arylene group which may be substituted, or a divalent linking group represented by the following Formula (IV). However, an unsubstituted naphthylene group is excluded.

One or more hydrogen atoms included in Ar⁴ may be substituted with a halogen atom, an alkyl group having 1 to 10 carbon atoms, or an aryl group having 6 to 20 carbon atoms.

Examples of the arylene group of Ar⁴ include a phenylene group and a biphenylylene group.

The halogen atom, alkyl group, and aryl group, which can substitute for one or more hydrogen atoms in the group represented by Ar⁴, are the same ones as the halogen atom, the alkyl group having 1 to 10 carbon atoms, and the aryl group having 6 to 20 carbon atoms, which can substitute for one or more hydrogen atoms in the above-described group represented by Ar¹.

When one or more hydrogen atoms in the group represented by Ar⁴ are substituted with these groups, the number of substitutions is preferably one or two, and more preferably one, each independently for the group represented by Ar⁴. It is more preferable that Ar⁴ is unsubstituted.

Examples of the alkylidene group having 1 to 10 carbon atoms include a methylene group, an ethylidene group, an isopropylidene group, an n-butylidene group, and a 2-ethylhexylidene group, and the carbon number thereof is preferably 1 to 10.

The constitutional unit (4) is a constitutional unit derived from a predetermined aromatic dicarboxylic acid.

Regarding the constitutional unit (4), it is preferable that Ar⁴ is a 1,4-phenylene group (a constitutional unit derived from terephthalic acid), that Ar⁴ is a 1,3-phenylene group (a constitutional unit derived from isophthalic acid), that Ar⁴ is a 4,4′-biphenylylene group (a constitutional unit derived from 4,4′-dicarboxybiphenyl), or that Ar⁴ is a diphenyl ether-4,4′-diyl group (a constitutional unit derived from 4,4′-dicarboxydiphenyl ether), and it is more preferable that Ar⁴ is a 1,4-phenylene group, a 1,3-phenylene group, or a 4,4′-biphenylylene group.

With regard to the liquid crystalline polyester according to the present embodiment, the amount of the constitutional unit represented by Formula (1) is preferably 30 to 80 mol %, more preferably 50 to 70 mol %, and even more preferably 55 to 65 mol %, with respect to the sum (100 mol %) of the constitutional unit represented by Formula (1), the constitutional unit represented by Formula (2), and the constitutional unit represented by Formula (3), all of which constitute the liquid crystalline polyester.

With regard to the liquid crystalline polyester according to the present embodiment, the amount of the constitutional unit represented by Formula (1) is preferably 30 to 80 mol %, more preferably 50 to 70 mol %, and even more preferably 55 to 65 mol %, with respect to the sum (100 mol %) of all the constitutional units constituting the liquid crystalline polyester.

With regard to the liquid crystalline polyester according to the present embodiment, the amount of the constitutional unit represented by Formula (2) is preferably 10 to 35 mol %, more preferably 15 to 30 mol %, even more preferably 17.5 to 27.5 mol %, and still more preferably 17.5 to 25 mol %, with respect to the sum (100 mol %) of the constitutional unit represented by Formula (1), the constitutional unit represented by Formula (2), and the constitutional unit represented by Formula (3), all of which constitute the liquid crystalline polyester.

With regard to the liquid crystalline polyester according to the present embodiment, the amount of the constitutional unit represented by Formula (2) is preferably 10 to 35 mol %, more preferably 15 to 30 mol %, even more preferably 17.5 to 27.5 mol %, and still more preferably 17.5 to 25 mol %, with respect to the sum (100 mol %) of all the constitutional units constituting the liquid crystalline polyester.

With regard to the liquid crystalline polyester according to the present embodiment, the amount of the constitutional unit represented by Formula (3) is preferably 10 mol % or more, more preferably 10 to 35 mol %, even more preferably 15 to 30 mol %, particularly preferably 17.5 to 27.5 mol %, and still more preferably 17.5 to 25 mol %, with respect to the sum (100 mol %) of the constitutional unit represented by Formula (1), the constitutional unit represented by Formula (2), and the constitutional unit represented by Formula (3), all of which constitute the liquid crystalline polyester.

With regard to the liquid crystalline polyester according to the present embodiment, the amount of the constitutional unit represented by Formula (3) is preferably 10 mol % or more, more preferably 10 to 35 mol %, even more preferably 15 to 30 mol %, particularly preferably 17.5 to 27.5 mol %, and still more preferably 17.5 to 25 mol %, with respect to the sum (100 mol %) of all the constitutional units constituting the liquid crystalline polyester.

With regard to the liquid crystalline polyester according to the present embodiment, the amount of the constitutional unit represented by Formula (4) is preferably 0 to 10 mol %, more preferably 0 to 5 mol %, and even more preferably 0 to 3 mol %, with respect to the sum (100 mol %) of the constitutional unit represented by Formula (1), the constitutional unit represented by Formula (2), and the constitutional unit represented by Formula (3), all of which constitute the liquid crystalline polyester.

With regard to the liquid crystalline polyester according to the present embodiment, the amount of the constitutional unit represented by Formula (4) is preferably 0 to 10 mol %, more preferably 0 to 5 mol %, and even more preferably 0 to 3 mol %, with respect to the sum (100 mol %) of all the constitutional units constituting the liquid crystalline polyester.

The liquid crystalline polyester according to the present embodiment has a flow starting temperature of preferably 270° C. or higher, more preferably 270° C. or higher and 400° C. or lower, even more preferably 280° C. or higher and 380° C. or lower, and particularly preferably 300° C. or higher and 350° C. or lower.

When the flow starting temperature of the liquid crystalline polyester according to the present embodiment is in the above-described range, the heat resistance, strength, and rigidity are satisfactory, the liquid crystalline polyester is less likely to be thermally deteriorated during molding, and the viscosity at melting is less likely to increase, so that there is a tendency that fluidity is less likely to be lowered.

The flow starting temperature, which is also called the flow temperature, is a temperature at which when a liquid crystalline polyester is melted while increasing the temperature at a rate of 4° C./min under a load of 9.8 MPa (100 kgf/cm²) by using a capillary rheometer and is extruded through a nozzle having an inner diameter of 1 mm and a length of 10 mm, the viscosity is 4800 Pa·s (48000 poise), and the flow starting temperature serves as a guideline for the molecular weight of a liquid crystalline polyester (see KOIDE, Naoyuki, ed., “Liquid Crystal Polymer—Synthesis, Molding, and Application—”, CMC Publications, LLC, Jun. 5, 1987, p. 95).

The liquid crystalline polyester of the present invention has the following aspects.

“11” A liquid crystalline polyester obtainable by reacting an aromatic diol (A) with an aromatic hydroxycarboxylic acid (B) and a naphthalenedicarboxylic acid (C),

in which the naphthalenedicarboxylic acid (C) is a naphthalenedicarboxylic acid powder including 90% by mass or more of naphthalenedicarboxylic acid particles (C1) having a particle size of less than 150 μm as measured by a dry sieving test method of JIS K 0069 (1992).

“12” A liquid crystalline polyester obtainable by the method for producing a liquid crystalline polyester according to any one of the above-described items “1” to “10”.

The liquid crystalline polyester of the present embodiment described above is a liquid crystalline polyester including 90% by mass or more of the naphthalenedicarboxylic acid particles (C1) having a particle size of less than 150 m with respect to 100% by mass of the total mass of the naphthalenedicarboxylic acid (C) in the above-mentioned method for producing a liquid crystalline polyester, and has excellent mechanical strength, particularly excellent tensile properties.

### EXAMPLES

Hereinafter, the present invention will be described in more detail by way of specific Examples. However, the present invention is not intended to be limited to the Examples shown below.

<Method for Measuring Particle Size of Naphthalenedicarboxylic Acid Powder>

The particle size of a naphthalenedicarboxylic acid powder was measured by a dry sieving test method of JIS K 0069 (1992) using a mesh sieve manufactured by Tokyo Screen Co., Ltd.

<Method for Measuring Median Particle Size (D50) of Naphthalenedicarboxylic Acid Powder>

0.1 g of a target naphthalenedicarboxylic acid powder was put into 50 mL of an aqueous solution to which Triton X-100 was added as a surfactant, and the mixture was dispersed with an ultrasonic cleaning apparatus for 10 minutes to prepare a dispersion liquid.

Next, this dispersion liquid was irradiated with a laser beam using a MicroTrac particle size analyzer (MT-3300EX11) manufactured by Nikkiso Co., Ltd., the particle size distribution of the naphthalenedicarboxylic acid powder was measured by a laser diffraction method, and a volume-based cumulative particle size distribution curve was obtained.

Then, in the obtained cumulative particle size distribution curve, the value of the particle size at the point where the cumulative volume from the fine particle side was 50% when the entirety thereof was set as 100%, was determined as the median particle size (D50).

<Naphthalenedicarboxylic Acid Powder>

A commercially available 2,6-naphthalenedicarboxylic acid powder was supplied for the synthesis of aromatic liquid crystalline polyesters of Comparative Examples 1 to 3.

When the particle size of this commercially available 2,6-naphthalenedicarboxylic acid powder was measured by a dry sieving test method, the powder included 84.9% by mass of naphthalenedicarboxylic acid particles (C1) having a particle size of less than 150 μm with respect to 100% by mass of the total mass of the 2,6-naphthalenedicarboxylic acid powder, and the proportion of particles having a size of 150 μm or more was 15.1% by mass. The particle size of this commercially available 2,6-naphthalenedicarboxylic acid powder was measured by a laser diffraction and scattering method, and the median particle size (D50) was 15 μm.

Furthermore, a 2,6-naphthalenedicarboxylic acid powder obtained by passing the commercially available naphthalenedicarboxylic acid powder through a sieve having a sieve opening of 150 μm was supplied for the synthesis of aromatic liquid crystalline polyesters of Examples 1, 3, and 5.

The particle size of the 2,6-naphthalenedicarboxylic acid powder obtained by passing the commercially available naphthalenedicarboxylic acid powder through a sieve having a sieve opening of 150 μm was measured by a dry sieving test method, and the powder included 100% by mass of naphthalenedicarboxylic acid particles (C1) having a particle size of less than 150 μm with respect to 100% by mass of the total mass of the 2,6-naphthalenedicarboxylic acid powder. The particle size of the 2,6-naphthalenedicarboxylic acid powder having its particle size adjusted to less than 150 μm by passing through a sieve having a sieve opening of 150 μm, was measured by a laser diffraction and scattering method, and the median particle size (D50) was 14 μm.

Furthermore, the 2,6-naphthalenedicarboxylic acid powder obtained by passing the commercially available naphthalenedicarboxylic acid powder through a sieve having a sieve opening of 150 μm and the 2,6-naphthalenedicarboxylic acid powder remaining on the sieve having a sieve opening of 150 μm were mixed at a mass ratio of 95:5, and the 2,6-naphthalenedicarboxylic acid powder thus obtained was supplied for the synthesis of aromatic liquid crystalline polyesters of Examples 2, 4, and 6.

When the particle size of this 2,6-naphthalenedicarboxylic acid powder was measured by a laser diffraction and scattering method, the median particle size (D50) was 14 μm.

<Measurement of Flow Starting Temperature>

For the liquid crystalline polyester of each example, the flow starting temperature was measured by using a flow tester (manufactured by Shimadzu Corporation, CFT-500 type). Specifically, about 2 g of the liquid crystalline polyester of each example was filled in a capillary type rheometer equipped with a die having an inner diameter of 1 mm and a length of 10 mm. Next, for the filled liquid crystalline polyester of each example, the temperature at which the melt viscosity was 4800 Pa-s (48000 poise) when the liquid crystalline polyester was extruded through the nozzle of the rheometer at a rate of temperature increase of 4° C./min under a load of 9.8 MPa (100 kgf/cm²), was designated as the flow starting temperature.

### Example 1

Into a reactor equipped with a stirrer, a torque meter, a nitrogen gas inlet tube, a thermometer, and a reflux condenser, 1129.1 g (6.00 mol) of 2-hydroxy-6-naphthoic acid, 226.8 g (2.06 mol) of hydroquinone, 432.4 g (2.00 mol) of a 2,6-naphthalenedicarboxylic acid powder having the particle size adjusted to less than 150 μm by passing through a sieve with a sieve opening of 150 μm, 1136.5 g (11.13 mol) of acetic anhydride, and 0.054 g of 1-methylimidazole as a catalyst were added, and the mixture was stirred at room temperature for 15 minutes and then was heated while being stirred. When the internal temperature reached 140° C., the mixture was stirred for 1 hour while being maintained at 140° C.

Next, the temperature was raised from 140° C. to 310° C. over 5 hours while distilling off by-product acetic acid and unreacted acetic anhydride that distilled out. The temperature was kept at 310° C. for 1 hour and 30 minutes to obtain an aromatic polyester. The obtained aromatic polyester was cooled to room temperature and pulverized with a pulverizer to obtain an aromatic polyester powder (the particle size was about 0.1 mm to about 2 mm).

The flow starting temperature of this powder (aromatic polyester) was measured, and it was found to be 279° C.

The obtained powder was heated from 25° C. to 270° C. over 1 hour, subsequently heated from 270° C. to 320° C. over 5 hours and 2 minutes, and then kept at 320° C. for 5 hours to cause solid phase polymerization. Subsequently, the powder obtained after solid phase polymerization was cooled, and the flow starting temperature of the cooled powder (aromatic liquid crystalline polyester) was measured, which was found to be 333° C.

### Example 2

An aromatic polyester powder (the particle size was about 0.1 mm to about 2 mm) was obtained by an operation similar to that in Example 1, except that 432.4 g (2.00 mol) of a 2,6-naphthalenedicarboxylic acid powder in which the proportion of particles having a particle size of less than 150 μm was 95.0% by mass and the proportion of particles having a particle size of 150 μm or larger was 5.0% by mass, was used as the raw material 2,6-naphthalenedicarboxylic acid.

The flow starting temperature of this powder (aromatic polyester) was measured, and it was found to be 279° C.

The obtained powder was heated from 25° C. to 270° C. over 1 hour, subsequently heated from 270° C. to 320° C. over 5 hours and 2 minutes, and then kept at 320° C. for 5 hours to cause solid phase polymerization. Subsequently, the powder obtained after solid phase polymerization was cooled, and the flow starting temperature of the cooled powder (aromatic liquid crystalline polyester) was measured, which was found to be 333° C.

### Comparative Example 1

An aromatic polyester powder (the particle size was about 0.1 mm to about 2 mm) was obtained by an operation similar to that in Example 1, except that 432.4 g (2.00 mol) of a 2,6-naphthalenedicarboxylic acid powder in which the proportion of particles having a particle size of less than 150 μm was 84.9% by mass and the proportion of particles having a particle size of 150 μm or larger was 15.1% by mass, was used as the raw material 2,6-naphthalenedicarboxylic acid.

The flow starting temperature of this powder (aromatic polyester) was measured, and it was found to be 277° C.

The obtained powder was heated from 25° C. to 270° C. over 1 hour, subsequently heated from 270° C. to 320° C. over 5 hours and 2 minutes, and then kept at 320° C. for 5 hours to cause solid phase polymerization. Subsequently, the powder obtained after solid phase polymerization was cooled, and the flow starting temperature of the powder after cooling (aromatic liquid crystalline polyester) was measured, which was found to be 331° C.

### Example 3

Into a reactor equipped with a stirrer, a torque meter, a nitrogen gas inlet tube, a thermometer, and a reflux condenser, 1091.4 g (5.80 mol) of 2-hydroxy-6-naphthoic acid, 238.2 g (2.16 mol) of hydroquinone, 33.2 g (0.20 mol) of terephthalic acid, 410.8 g (1.90 mol) of a 2,6-naphthalenedicarboxylic acid powder having the particle size adjusted to less than 150 μm by passing through a sieve with a sieve opening of 150 μm, 1137.1 g (11.14 mol) of acetic anhydride, and 0.053 g of 1-methylimidazole as a catalyst were added, and the mixture was stirred at room temperature for 15 minutes and then was heated while being stirred. When the internal temperature reached 140° C., the mixture was stirred for 1 hour while being maintained at 140° C.

Next, the temperature was raised from 140° C. to 310° C. over 4 hours and 20 minutes while distilling off by-product acetic acid and unreacted acetic anhydride that distilled out. The temperature was kept at 310° C. for 1 hour and 30 minutes to obtain an aromatic polyester. The obtained aromatic polyester was cooled to room temperature and pulverized with a pulverizer to obtain an aromatic polyester powder (the particle size was about 0.1 mm to about 2 mm).

The flow starting temperature of this powder (aromatic polyester) was measured, and it was found to be 242° C.

The obtained powder was heated from 25° C. to 240° C. over 1 hour, subsequently heated from 240° C. to 310° C. over 11 hours and 40 minutes, and then kept at 310° C. for 5 hours to cause solid phase polymerization. Subsequently, the powder obtained after solid phase polymerization was cooled, and the flow starting temperature of the powder after cooling (aromatic liquid crystalline polyester) was measured, which was found to be 325° C.

### Example 4

An aromatic polyester powder (the particle size was about 0.1 mm to about 2 mm) was obtained by an operation similar to that in Example 3, except that 410.8 g (1.90 mol) of a 2,6-naphthalenedicarboxylic acid powder in which the proportion of particles having a particle size of less than 150 μm was 95.0% by mass and the proportion of particles having a particle size of 150 μm or larger was 5.0% by mass, was used as the raw material 2,6-naphthalenedicarboxylic acid.

The flow starting temperature of this powder (aromatic polyester) was measured, and it was found to be 241° C.

The obtained powder was heated from 25° C. to 240° C. over 1 hour, subsequently heated from 240° C. to 310° C. over 11 hours and 40 minutes, and then kept at 310° C. for 5 hours to cause solid phase polymerization. Subsequently, the powder obtained after solid phase polymerization was cooled, and the flow starting temperature of the powder after cooling (aromatic liquid crystalline polyester) was measured, which was found to be 324° C.

### Comparative Example 21

An aromatic polyester powder (the particle size was about 0.1 mm to about 2 mm) was obtained by an operation similar to that in Example 3, except that 410.8 g (1.90 mol) of a 2,6-naphthalenedicarboxylic acid powder in which the proportion of particles having a particle size of less than 150 μm was 84.9% by mass and the proportion of particles having a particle size of 150 μm or larger was 15.1% by mass, was used as the raw material 2,6-naphthalenedicarboxylic acid.

The flow starting temperature of this powder (aromatic polyester) was measured, and it was found to be 242° C.

The obtained powder was heated from 25° C. to 240° C. over 1 hour, subsequently heated from 240° C. to 310° C. over 11 hours and 40 minutes, and then kept at 310° C. for 5 hours to cause solid phase polymerization. Subsequently, the powder obtained after solid phase polymerization was cooled, and the flow starting temperature of the powder after cooling (aromatic liquid crystalline polyester) was measured, which was found to be 325° C.

### Example 5

Into a reactor equipped with a stirrer, a torque meter, a nitrogen gas inlet tube, a thermometer, and a reflux condenser, 828.7 g (6.00 mol) of 4-hydroxybenzoic acid, 226.8 g (2.06 mol) of hydroquinone, 432.4 g (2.00 mol) of a 2,6-naphthalenedicarboxylic acid powder having the particle size adjusted to less than 150 μm by passing through a sieve with a sieve opening of 150 μm, 1136.5 g (11.13 mol) of acetic anhydride, and 0.045 g of 1-methylimidazole as a catalyst were added, and the mixture was stirred at room temperature for 15 minutes and then was heated while being stirred. When the internal temperature reached 140° C., the mixture was stirred for 1 hour while being maintained at 140° C.

Next, the temperature was raised from 140° C. to 300° C. over 5 hours while distilling off by-product acetic acid and unreacted acetic anhydride that distilled out. The temperature was kept at 300° C. for 1 hour and 30 minutes to obtain an aromatic polyester. The obtained aromatic polyester was cooled to room temperature and pulverized with a pulverizer to obtain an aromatic polyester powder (the particle size was about 0.1 mm to about 2 mm).

The flow starting temperature of this powder (aromatic polyester) was measured, and it was found to be 253° C.

The obtained powder was heated from 25° C. to 240° C. over 1 hour, subsequently heated from 240° C. to 300° C. over 10 hours, and then kept at 300° C. for 5 hours to cause solid phase polymerization. Subsequently, the powder obtained after solid phase polymerization was cooled, and the flow starting temperature of the powder after cooling (aromatic liquid crystalline polyester) was measured, which was found to be 308° C.

### Example 6

An aromatic polyester powder was obtained by an operation similar to that in Example 5, except that 432.4 g (2.00 mol) of a 2,6-naphthalenedicarboxylic acid powder in which the proportion of particles having a particle size of less than 150 μm was 95.0% by mass and the proportion of particles having a particle size of 150 μm or larger was 5.0% by mass, was used as the raw material 2,6-naphthalenedicarboxylic acid. The flow starting temperature of this powder (aromatic polyester) was measured, and it was found to be 257° C.

The obtained powder was heated from 25° C. to 240° C. over 1 hour, subsequently heated from 240° C. to 300° C. over 10 hours, and then kept at 300° C. for 5 hours to cause solid phase polymerization. Subsequently, the powder obtained after solid phase polymerization was cooled, and the flow starting temperature of the powder after cooling (aromatic liquid crystalline polyester) was measured, which was found to be 309° C.

### Comparative Example 3

An aromatic polyester powder was obtained by an operation similar to that in Example 5, except that 432.4 g (2.00 mol) of a 2,6-naphthalenedicarboxylic acid powder in which the proportion of particles having a particle size of less than 150 μm was 84.9% by mass and the proportion of particles having a particle size of 150 μm or larger was 15.1% by mass, was used as the raw material 2,6-naphthalenedicarboxylic acid. The flow starting temperature of this powder (aromatic polyester) was measured, and it was found to be 257° C.

The obtained powder was heated from 25° C. to 240° C. over 1 hour, subsequently heated from 240° C. to 300° C. over 10 hours, and then kept at 300° C. for 5 hours to cause solid phase polymerization. Subsequently, the powder obtained after solid phase polymerization was cooled, and the flow starting temperature of the powder after cooling (aromatic liquid crystalline polyester) was measured, which was found to be 310° C.

<Evaluation of Mechanical Strength (Tensile Strength, Elongation) of Molded Body>

An aromatic liquid crystalline polyester obtained by each of the Examples and Comparative Examples was vacuum-dried at 120° C. for 5 hours, and a dumbbell test specimen (thickness 0.5 mm, length 76 mm) was injection-molded by using an injection molding machine (“PNX-40-5A” manufactured by Nissei Plastic Industrial Co., Ltd.) under the molding conditions of a cylinder temperature: 350° C.

Twenty samples each of this test specimen was subjected to a tensile test according to ASTM D638, by using a tensile tester (Tensilon RTG-1250, manufactured by A & D Co., Ltd.), at a distance between chucks: 50 mm, a crosshead speed: 10 mm/min, a test temperature: 25° C., the tensile strength and the elongation at that time were measured, and the average values and the standard deviations of the tensile strength at break (MPa) and the tensile elongation at break (%) were determined. The results are shown in Table 1. In Table 1, the polymer composition of the aromatic liquid crystalline polyester of each of the Examples and Comparative Examples shows the content (mol %) of each constitutional unit with respect to the sum (100 mol %) of all the constitutional units.

TABLE 1

| | | | | | Comparative | | |
|---|---|---|---|---|---|---|---|
| | | | Example 1 | Example 2 | Example 1 | Example 3 | Example 4 |
| Polymer | (B) Constitutional unit (1) | | 60 | 60 | 60 | 58 | 58 |
| composition | corresponding to BON (mol %) | | | | | | |
| | (B) Constitutional unit (1) | | | | | | |
| | corresponding to POB (mol %) | | | | | | |
| | (A) Constitutional unit (2) | | 20 | 20 | 20 | 21 | 21 |
| | corresponding to HQ (mol %) | | | | | | |
| | (C) Constitutional unit (3) | | 20 | 20 | 20 | 19 | 19 |
| | corresponding to NDCA (mol %) | | | | | | |
| | (D) Constitutional unit (4) | | | | | 2 | 2 |
| | corresponding to TPA (mol %) | | | | | | |
| (C) NDCA | Proportion of particles having particle | | 100.0 | 95.0 | 84.9 | 100.0 | 95.0 |
| particle size | size of less than 150 μm (% by mass) | | | | | | |
| | Proportion of particles having particle | | 0.0 | 5.0 | 15.1 | 0.0 | 5.0 |
| | size of 150 μm or more (% by mass) | | | | | | |
| Flow starting | | (° C.) | 333 | 333 | 331 | 325 | 324 |
| temperature | | | | | | | |
| Tensile | Tensile | Average value (MPa) | 156 | 145 | 123 | 223 | 218 |
| properties | strength | Standard deviation (MPa) | 8.5 | 9.0 | 9.8 | 12.9 | 13.2 |
| | Tensile | Average value (%) | 1.2 | 1.1 | 0.9 | 2.2 | 2.1 |
| | elongation | Standard deviation (%) | 0.1 | 0.1 | 0.1 | 0.2 | 0.2 |

| | | | Comparative | | | Comparative |
|---|---|---|---|---|---|---|
| | | | Example 2 | Example 5 | Example 6 | Example 3 |
| Polymer | (B) Constitutional unit (1) | | 58 | | | |
| composition | corresponding to BON (mol %) | | | | | |
| | (B) Constitutional unit (1) | | | 60 | 60 | 60 |
| | corresponding to POB (mol %) | | | | | |
| | (A) Constitutional unit (2) | | 21 | 20 | 20 | 20 |
| | corresponding to HQ (mol %) | | | | | |
| | (C) Constitutional unit (3) | | 19 | 20 | 20 | 20 |
| | corresponding to NDCA (mol %) | | | | | |
| | (D) Constitutional unit (4) | | 2 | | | |
| | corresponding to TPA (mol %) | | | | | |
| (C) NDCA | Proportion of particles having particle | | 84.9 | 100.0 | 95.0 | 84.9 |
| particle size | size of less than 150 μm (% by mass) | | | | | |
| | Proportion of particles having particle | | 15.1 | 0.0 | 5.0 | 15.1 |
| | size of 150 μm or more (% by mass) | | | | | |
| Flow starting | | (° C.) | 325 | 308 | 309 | 310 |
| temperature | | | | | | |
| Tensile | Tensile | Average value (MPa) | 209 | 127 | 120 | 109 |
| properties | strength | Standard deviation (MPa) | 14.6 | 7.0 | 7.9 | 9.6 |
| | Tensile | Average value (%) | 1.9 | 3.2 | 3.0 | 2.6 |
| | elongation | Standard deviation (%) | 0.2 | 0.3 | 0.3 | 0.4 |

### EXPLANATION OF ABBREVIATIONS IN TABLE 1

BON: 2-Hydroxy-6-naphthoic acid
POB: 4-Hydroxybenzoic acid
HQ: Hydroquinone
NDCA: 2,6-Naphthalenedicarboxylic acid
TPA: Terephthalic acid

As is obvious from the results in Table 1, the aromatic liquid crystalline polyesters of Examples 1 and 2 and the aromatic liquid crystalline polyester of Comparative Example 1 have the same composition and have nearly equal flow starting temperatures, that is, nearly equal molecular weights. Nevertheless, the tensile strength and the elongation at that time of the aromatic liquid crystalline polyesters of Examples 1 and 2 are obviously superior to the tensile strength and the elongation at that time of the aromatic liquid crystalline polyester of Comparative Example 1.

Similarly, the aromatic liquid crystalline polyesters of Examples 3 and 4 and the aromatic liquid crystalline polyester of Comparative Example 2 have the same composition and have nearly equal flow starting temperatures and nearly equal molecular weights. Nevertheless, the tensile strength and the elongation at that time of the aromatic liquid crystalline polyester of Examples 3 and 4 are obviously superior to the tensile strength and the elongation at that time of the aromatic liquid crystalline polyester of Comparative Example 2.

Similarly, the aromatic liquid crystalline polyesters of Examples 5 and 6 and the aromatic liquid crystalline polyester of Comparative Example 3 have the same composition and have nearly equal flow starting temperatures and nearly equal molecular weights. Nevertheless, the tensile strength and the elongation at that time of the aromatic liquid crystalline polyesters of Examples 5 and 6 are obviously superior to the tensile strength and the elongation at that time of the aromatic liquid crystalline polyester of Comparative Example 3.

The aromatic liquid crystalline polyesters of Examples 1 to 6 are liquid crystalline polyesters each obtained by reacting an aromatic diol (A) with an aromatic hydroxycarboxylic acid (B) and a naphthalenedicarboxylic acid (C), and the naphthalenedicarboxylic acid (C) is a naphthalenedicarboxylic acid powder including 90% by mass or more of naphthalenedicarboxylic acid particles (C1) having a particle size of less than 150 μm as measured by the dry sieving test method of JIS K 0069 (1992) with respect to 100% by mass of the total mass of the naphthalenedicarboxylic acid (C). In contrast, the aromatic liquid crystalline polyesters of Comparative Examples 1 to 3 are liquid crystalline polyesters each obtained by reacting a 2,6-naphthalenedicarboxylic acid powder in which the proportion of the particles having a particle size of less than 150 μm is 84.9% by mass and the proportion of particles having a particle size of 150 μm or greater is 15.1% by mass.

For the occasion of distinguishing the aromatic liquid crystalline polyesters according to the Examples from the aromatic liquid crystalline polyesters according to the Comparative Examples, it was examined to directly specify them by the structure or the characteristics thereof; however, they could not be distinguished by the data of conventional various spectra utilized in specifying of compounds. It is considered that there are impossible and impractical circumstances for directly specifying an aromatic liquid crystalline polyester according to the Examples by means of the structure or characteristics thereof, and the aromatic liquid crystalline polyester can be specified only by considering the producing method.

### INDUSTRIAL APPLICABILITY

The method for producing a liquid crystalline polyester of the present invention allows producing of a liquid crystalline polyester having excellent mechanical strength, particularly excellent tensile properties, as compared with a liquid crystalline polyester having the same composition and manufactured by using a conventional naphthalenedicarboxylic acid, and therefore, the method is useful. Since the liquid crystalline polyester obtainable from the producing method of the present invention is excellent in terms of the mechanical strength such as tensile properties, the heat resistance, and the chemical resistance, utilization of the liquid crystalline polyester in various use applications as a material for thin-walled electronic components concomitant to the size reduction of electronic components.

1. A method for producing a liquid crystalline polyester,
the method comprising reacting an aromatic diol (A), an aromatic hydroxycarboxylic acid (B), and a naphthalenedicarboxylic acid (C) to obtain a liquid crystalline polyester,
wherein the naphthalenedicarboxylic acid (C) is a naphthalenedicarboxylic acid powder including 90% by mass or more of naphthalenedicarboxylic acid particles (C1) having a particle size of less than 150 μm as measured by a dry sieving test method of JIS K 0069 (1992).

2. The method for producing a liquid crystalline polyester according to claim 1,
wherein an amount of use of the naphthalenedicarboxylic acid (C) is 10 mol % or more with respect to a total amount of use (100 mol %) of the aromatic diol (A), the aromatic hydroxycarboxylic acid (B), and the naphthalenedicarboxylic acid (C).

3. The method for producing a liquid crystalline polyester according to claim 1,
wherein the naphthalenedicarboxylic acid (C) is at least one selected from the group consisting of 2,6-naphthalenedicarboxylic acid, 2,7-naphthalenedicarboxylic acid, and 1,4-naphthalenedicarboxylic acid.

4. The method for producing a liquid crystalline polyester according to claim 1,
wherein a median particle size (D50) of the naphthalenedicarboxylic acid powder measured by a laser diffraction and scattering method is 5 to 30 μm.

5. The method for producing a liquid crystalline polyester according to claim 1,
wherein the method has
a step (i) of subjecting at least one of the aromatic diol (A) and the aromatic hydroxycarboxylic acid (B) to an acylation reaction with a fatty acid anhydride to obtain an acylation product, and
a step (ii) of subjecting the acylation product and the naphthalenedicarboxylic acid (C) to a transesterification reaction to obtain a liquid crystalline polyester.

6. The method for producing a liquid crystalline polyester according to claim 5,
wherein the transesterification reaction in the step (ii) is carried out from 250° C. to 350° C.

7. The method for producing a liquid crystalline polyester according to claim 1,
wherein the method has
a step (iii) of preparing a naphthalenedicarboxylic acid powder including 90% by mass or more of the naphthalenedicarboxylic acid particles (C1), and
the step (iii) includes
an operation (a) of classifying naphthalenedicarboxylic acid (C0) into the naphthalenedicarboxylic acid particles (C1) and naphthalenedicarboxylic acid particles (C2) having a particle size of 150 μm or more, by the dry sieving test method of JIS K 0069 (1992).

8. The method for producing a liquid crystalline polyester according to claim 1,
wherein the method has
a step (iii) of preparing a naphthalenedicarboxylic acid powder including 90% by mass or more of the naphthalenedicarboxylic acid particles (C1), and
the step (iii) includes
an operation (a) of classifying naphthalenedicarboxylic acid (C0) into the naphthalenedicarboxylic acid particles (C1) and naphthalenedicarboxylic acid particles (C2) having a particle size of 150 μm or more, by the dry sieving test method of JIS K 0069 (1992),
an operation (b) of processing the naphthalenedicarboxylic acid particles (C2) to produce naphthalenedicarboxylic acid particles (C2*) having a particle size adjusted to less than 150 μm, and
an operation (c) of mixing the naphthalenedicarboxylic acid particles (C1) obtained by the operation (a) with the naphthalenedicarboxylic acid particles (C2*) obtained by the operation (b).

9. A liquid crystalline polyester obtainable by reacting an aromatic diol (A), an aromatic hydroxycarboxylic acid (B), and a naphthalenedicarboxylic acid (C),
wherein the naphthalenedicarboxylic acid (C) is a naphthalenedicarboxylic acid powder including 90% by mass or more of naphthalenedicarboxylic acid particles (C1) having a particle size of less than 150 μm as measured by a dry sieving test method of JIS K 0069 (1992).

10. The method for producing a liquid crystalline polyester according to claim 2,
wherein the naphthalenedicarboxylic acid (C) is at least one selected from the group consisting of 2,6-naphthalenedicarboxylic acid, 2,7-naphthalenedicarboxylic acid, and 1,4-naphthalenedicarboxylic acid.

11. The method for producing a liquid crystalline polyester according to claim 2,
wherein a median particle size (D50) of the naphthalenedicarboxylic acid powder measured by a laser diffraction and scattering method is 5 to 30 μm.

12. The method for producing a liquid crystalline polyester according to claim 2,
wherein the method has
a step (i) of subjecting at least one of the aromatic diol (A) and the aromatic hydroxycarboxylic acid (B) to an acylation reaction with a fatty acid anhydride to obtain an acylation product, and
a step (ii) of subjecting the acylation product and the naphthalenedicarboxylic acid (C) to a transesterification reaction to obtain a liquid crystalline polyester.

13. The method for producing a liquid crystalline polyester according to claim 2,
wherein the method has
a step (iii) of preparing a naphthalenedicarboxylic acid powder including 90% by mass or more of the naphthalenedicarboxylic acid particles (C1), and
the step (iii) includes
an operation (a) of classifying naphthalenedicarboxylic acid (C0) into the naphthalenedicarboxylic acid particles (C1) and naphthalenedicarboxylic acid particles (C2) having a particle size of 150 μm or more, by the dry sieving test method of JIS K 0069 (1992).

14. The method for producing a liquid crystalline polyester according to claim 2,
wherein the method has
a step (iii) of preparing a naphthalenedicarboxylic acid powder including 90% by mass or more of the naphthalenedicarboxylic acid particles (C1), and
the step (iii) includes
an operation (a) of classifying naphthalenedicarboxylic acid (C0) into the naphthalenedicarboxylic acid particles (C1) and naphthalenedicarboxylic acid particles (C2) having a particle size of 150 μm or more, by the dry sieving test method of JIS K 0069 (1992),
an operation (b) of processing the naphthalenedicarboxylic acid particles (C2) to produce naphthalenedicarboxylic acid particles (C2*) having a particle size adjusted to less than 150 μm, and
an operation (c) of mixing the naphthalenedicarboxylic acid particles (C1) obtained by the operation (a) with the naphthalenedicarboxylic acid particles (C2*) obtained by the operation (b).
